(19) United States
(12) Patent Application Publication
(10) Pub. No.: US 2009/0020707 A1
(43) Pub. Date: Jan. 22, 2009

(54) Particle beam application apparatus, radiation device and method for guiding a particle beam

(76) Inventors: Thomas Hansmann, Heidelberg (DE); Eike Rietzel, Darmstadt (DE)

Correspondence Address: BRINKS HOFER GILSON & LIONE, P.O. BOX 10395, CHICAGO, IL, 60610, US

(21) Appl. No.: 12/218,089

(22) Filed: Jul. 11, 2008

Related U.S. Application Data
(60) Provisional application No. 60/961,461, filed on Jul. 20, 2007.

(30) Foreign Application Priority Data
Jul. 20, 2007 (DE) DE 102007033895.5

(51) Int. Cl. H01J 3/14

(52) U.S. Cl. 250/396 ML

(57) ABSTRACT

The present embodiments relate to a particle beam application apparatus for shaping and guiding a particle beam. The particle beam application apparatus comprises a first collimator for shaping a cross-sectional profile of a particle beam entering the collimator, whereby the first collimator has an aperture which is customized to a target volume to be irradiated, and a magnet system for deflecting the particle beam which is arranged in the beam path of the particle beam downstream of the first collimator, whereby the magnet system can be used to generate a magnetic field with which the particle beam can be fanned out spectrally. The invention also relates to a radiation device having such a particle beam application apparatus, and a method for guiding a particle beam in which a particle beam is customized to a target volume by means of a collimator and is then directed by means of a magnet system, as a result of which the particle beam is cleansed of scattered radiation.

The present patent document claims the benefit of the filing date of DE 10 2007 033 895.5, filed Jul. 20, 2007, which is hereby incorporated by reference. The present patent document also claims the benefit of the filing date of U.S. provisional application 60/961,461, filed Jul. 20, 2007, which is also hereby incorporated by reference.

### BACKGROUND

The present embodiments relate to a particle beam application apparatus.

Particle therapy is an established method for the treatment of tissue, such as tumor diseases. Radiation methods, as they are used in particle therapy, can be applied in non-therapeutic fields. The non-therapeutic fields may include, for example, research work within the framework of particle therapy, carried out on non-living phantoms or bodies, or irradiation processes performed on materials. Charged particles are normally accelerated to high energies, shaped into a particle beam, and directed at an object to be irradiated. The particle beam penetrates into the object and delivers its energy there at a defined location, which results in the destruction of the tissue situated at that location. The particles used are typically protons and carbon ions, but pions, helium ions or other ion types are also employed.

After particles have been accelerated and a particle beam has been shaped, the particle beam is directed in as precisely targeted a manner as possible onto a target volume to be irradiated in order that the energy of the particle beam is deposited as precisely as possible at a predefined target location.

A method, such as a “scattering method”, expands the particle beam in a cone shape using a scattering device and then to direct it onto the target volume to be irradiated. A scattering device may include two scattering layers. The scattering device and the patient are in one line. The particle beam is limited in its extent by diaphragms or collimators, which are often produced and customized on a patient-specific basis.

The depth of penetration of the particle beam into a target volume to be irradiated depends on the energy level of the particle beam. In order to customize the particle beam to a target volume situated at different depths in the target body, for example, in order to thus correctly achieve a so-called depth coverage, elements are incorporated into the beam path of the particle beam which attenuate the energy of the particle beam location-specifically in particular, using compensators, for example. A general expansion of the particle beam at a depth is often required in order to achieve a broad depth coverage. Such types of elements include, for example, modulator wheels or ridge filters.

Secondary radiation is generated at all elements in the beam path of the particle beam at which an interaction occurs between material and the particle beam. The secondary radiation, which, for example, includes neutron radiation, can result in an energy deposition by the particles of the secondary radiation in the target volume at an undesired location. The quality of an irradiation operation is restricted as a result of this.

### SUMMARY AND DESCRIPTION

The present embodiments may obviate one or more of the drawbacks or limitations inherent in the related art. For example, in one embodiment, a particle beam application apparatus directs a particle beam onto a target volume to be irradiated, whereby the target volume is only burdened by slight secondary radiation. In another example, a radiation device irradiates a target volume with only a slight encumbrance through secondary radiation. In another example, a particle beam experiences only slight contamination caused by secondary radiation during a method for guiding a particle beam.

In one embodiment, a particle beam application apparatus is operable to shape and guide a particle beam, such that the particle beam may be directed onto a target volume to be irradiated. The particle beam application apparatus includes a first collimator and a magnet system.

The first collimator is operable to shape a cross-sectional profile of a particle beam entering the collimator. The first collimator has an aperture, which is customized for a target volume to be irradiated,

The magnet system is operable to deflect the particle beam. The magnet system is arranged in the beam path of the particle beam downstream of the first collimator. The magnet system may be used to generate a magnetic field with which the particle beam may be fanned out spectrally.

A particle beam, which passes through a collimator, is contaminated by scattered radiation. In order to decontaminate the particle beam contaminated by scattered radiation the particle beam is fanned out spectrally by a magnetic field. The components of the particle beam are deflected differently in the magnetic field according to their mass-to-charge ratio and/or according to their impulse. The scattered radiation, which is contained in the particle beam, may be spatially separated from the particles which are used for the irradiation. The scattered radiation has a different mass-to-charge ratio and/or a different energy or impulse than the particles with which an irradiation is performed which have a desired mass-to-charge ratio and a desired energy or impulse. The scattered radiation includes, for example, electrons or fragments which originate from the material of the collimator. The scattered radiation includes uncharged particles, such as photons or neutrons, for example, which then experience no deflection in the magnetic field.

The collimator may be implemented as a simple diaphragm having a rectangular aperture, with a simple slit diaphragm, for example.

In one embodiment, the first collimator for shaping the cross-sectional profile of the particle beam entering the first collimator may be implemented in such a manner in this situation that the collimator merely attenuates the energy of those particles of the particle beam, which do not pass through the aperture of the collimator.

The collimator differs considerably from collimators, which completely remove those particles of the particle beam that do not pass through the aperture of the collimator from the particle beam. With regard to the collimator, the particles which do not pass through the aperture of the collimator, merely have their energy attenuated. The spatial separation of these particles from the particles, which have been guided through the aperture of the collimator is effected by the magnetic field, which deflects the particle beam. The collimator may be manufactured considerably more slimly and more cheaply since it merely needs to attenuate the energy of particles and does not need to completely remove these particles—using absorption, for example—from the particle beam.

A conventional collimator, with which particles that do not pass through the aperture of the collimator are removed from the particle beam, may be used.

In one embodiment, the deflection of the particle beam generated by the magnet system is more than 5°, in particular more than 10°. An effective spatial separation of the scattered radiation from desired components of the particle beam is achieved. The magnet system may generate the magnetic field. The magnet system may include at least one dipole magnet.

The first collimator may be a collimator, which is produced individually for the target volume to be irradiated. A precise customization of the collimator to the target volume to be irradiated is guaranteed. A multi-leaf collimator, which permits a flexible customization to the target volume to be irradiated may be used as the collimator. As a further option, a collimator may be assembled from ready-made elements can be used as the collimator. A customization of the collimator and its aperture to the target volume to be irradiated may be achieved without always producing a new collimator.

The particle beam application apparatus may include a beam expansion device, which is arranged in the beam path upstream of the first collimator. The beam expansion device may include one or more scattering layers. The scattered radiation originating from the expansion device is removed effectively from the particle beam by the downstream components.

In one embodiment, the particle beam application apparatus includes a second collimator, with which the cross-sectional profile of the particle beam emerging from the magnet system can be limited. The second collimator is arranged downstream of the magnet system in the beam path.

The cross-sectional profile of the particle beam is re-shaped by the second collimator. When a second collimator is used, the first collimator does not need to be implemented so precisely and the cross-sectional profile of the particle beam does not need to be shaped so precisely because possible inaccuracies can be compensated for by the second collimator. Conversely, the second collimator can be implemented less precisely in its beam-limiting characteristic if the cross-sectional profile of the particle beam has already been shaped precisely by the first collimator.

The particle beam can be customized more precisely again to the target volume to be irradiated by the second collimator. A geometric expansion of the particle beam, which occurs according to the theorem on intersecting lines after the beam has traveled a distance, may be compensated for again.

In the same way as the first collimator, the second collimator can be a collimator produced individually for the target volume to be irradiated, a collimator, which can be assembled from ready-made elements, or a multi-leaf collimator.

A radiation device may include at least one particle beam application apparatus as, at least one source for generating particles, and at least one acceleration device arranged upstream of the particle beam application apparatus in order to accelerate the particles and to generate the particle beam from the accelerated particles.

A method for guiding a particle beam is provided. The method may include: shaping a cross-sectional profile of a particle beam in particular in such a manner that the particle beam is customized to a target volume to be irradiated, and guiding the shaped particle beam by a magnetic field, as a result of which the particle beam is deflected and fanned out spectrally.

The components or particles of the particle beam having an undesired mass-to-charge ratio or an undesired energy of the particles which are to irradiate a target volume are spatially separated.

The shaping of the cross-sectional profile of the particle beam may be effected by a collimator, through whose aperture the particle beam passes. The collimator may be constructed in such a manner that those particles, which do not pass through the aperture of the collimator merely have their energy attenuated instead of being removed completely from the particle beam. Before the cross-sectional profile is shaped the particle beam may be expanded.

After the particle beam has been fanned out spectrally by the magnetic field the cross-sectional profile of the particle beam can be shaped once again. The particle beam has its cross-sectional profile shaped by a collimator in such a manner that particles which do not pass through the aperture of the collimator are removed from the particle beam, for example, by being absorbed by the collimator.

The energy of the particles of the particle beam may be set upstream of the deflection of the particle beam by means of a depth modulation device. However, other arrangements for the depth modulation device are also possible, such as downstream of the deflection for example.

### BRIEF DESCRIPTION OF THE DRAWINGS

FIG. 1 shows one embodiment of a particle therapy system,

FIG. 2 shows one embodiment of a particle beam application apparatus,

FIGS. 3 and 4 show further embodiments of a particle beam application apparatus, and

FIG. 5 shows one embodiment of a method for guiding a particle beam.

### DETAILED DESCRIPTION

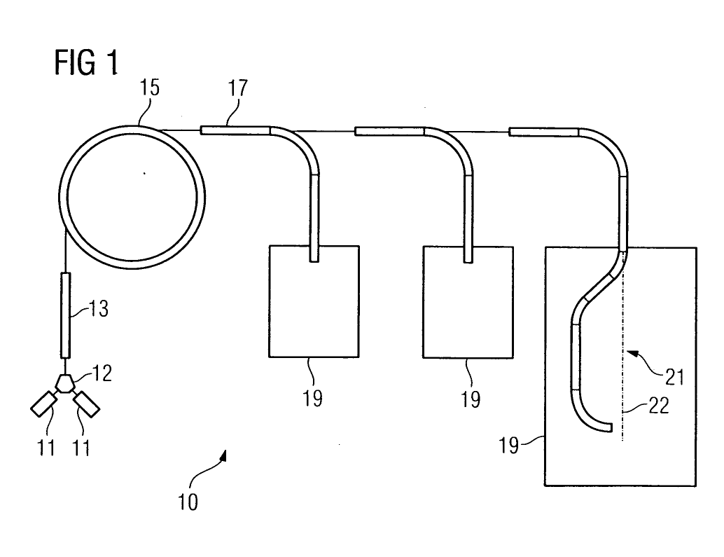

FIG. 1 shows a particle therapy system 10. Using a particle therapy system 10, a particle beam may irradiate a body, such as tissue having tumor disease.

The particles may include, for example, ions, such as protons, pions, helium ions, carbon ions, or other ion types. The particles are usually generated in a particle source 11. If, as illustrated in FIG. 1, two particle sources 11 are present which generate two different types of ions, it is possible to switch between the two ion types within a short time interval. A switching magnet 12 may be used to switch between the two ion types. The switching magnet 12 may be arranged between the ion sources 11 and a preaccelerator 13. In one example, the particle therapy system 10 operates using protons and carbon ions at the same time.

A preaccelerator 13 may accelerate ions to a first energy level. For example, the preaccelerator 13 may accelerate the ions generated by one or more of the ion sources 11 and where applicable selected using the switching magnet 12 to a first energy level. The preaccelerator 13 is, for example, a linear accelerator (LINAC: “LINear ACcelerator”). The particles are subsequently fed into an accelerator 15, for example, a synchrotron or cyclotron. In the accelerator 15 the particles are accelerated to high energy levels, such as are required for the irradiation process. After the particles exit the accelerator 15, a high-energy beam transport system 17 guides the particle beam to one or more irradiation chambers 19. The accelerated particles are directed onto a body to be irradiated in an irradiation chamber 19. Depending on the embodiment, this is done either from a fixed direction (in a “fixed beam” chamber) or from different directions by way of a rotatable gantry 21, which moves around an axis 22.

The particle therapy system 10, which is illustrated with reference to FIG. 1, may differ from the illustration; for example, depending on the acceleration of the particles, a radiation device may not need to be arranged as a particle therapy system.

The exemplary embodiments described in the following may be used both in conjunction with the particle therapy system 10 illustrated in FIG. 1 and with other particle therapy systems or beam therapy systems.

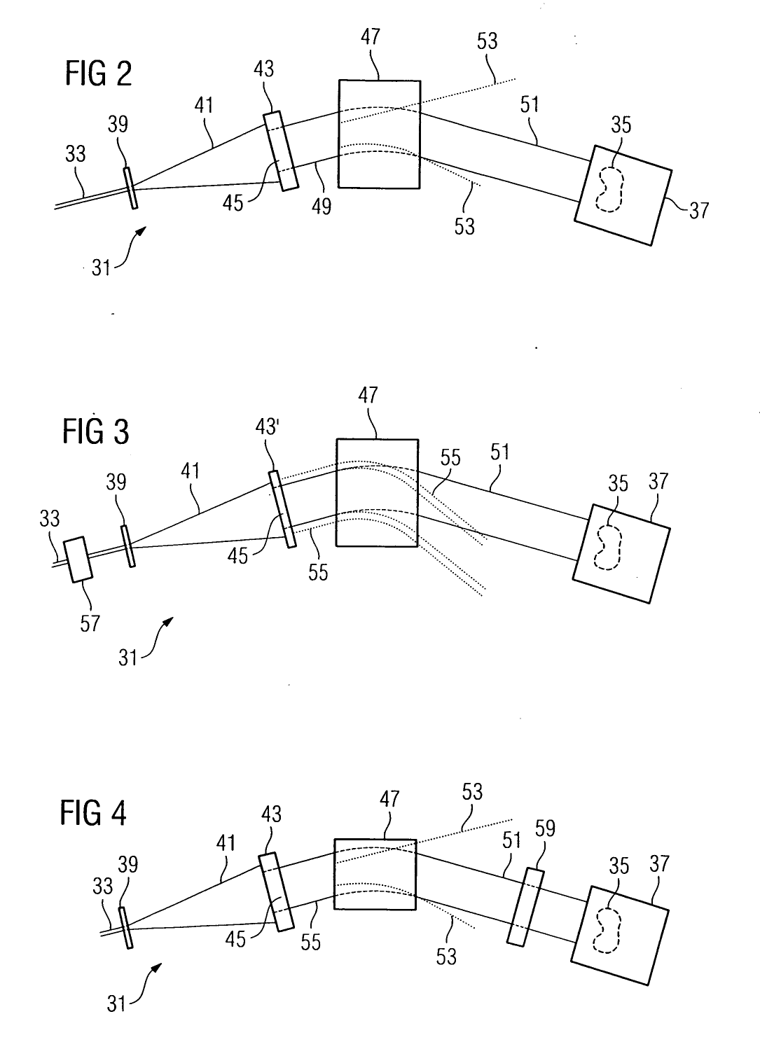

FIG. 2 illustrates a particle beam application apparatus 31. The particle beam application apparatus 31 is shown from a top view. A particle beam 33 entering the particle beam application apparatus 31 is shaped and guided by the particle beam application apparatus 31 before it strikes a target volume 35 to be irradiated, which is situated inside an object 37 to be irradiated.

The entering particle beam 33 strikes a beam expansion device 39. From the entering particle beam 33, which previously has an essentially point-shaped cross-sectional profile, the beam expansion device 39 generates an expanded particle beam 41 with a two-dimensional cross-sectional profile by expanding the particle beam in a cone shape. The expanded particle beam 41 strikes a first collimator 43. The first collimator 43 has an aperture 45, which is customized to the target volume 35.

After the particle beam has been shaped in its cross-sectional profile by the first collimator 43, the particle beam is guided by a magnet system 47. The magnet system 47 includes a dipole magnet, which generates a magnetic field that is used to deflect the path of the shaped particle beam 49. After the particle beam has been deflected, the deflected particle beam 51 is directed onto the target volume 35 to be irradiated.

When the particle beam passes through the beam expansion device 39 or through the first collimator 43, an interaction occurs between the particle beam and a material. Accordingly, particles are generated in the particle beam which exhibit a different mass-to-charge ratio and/or have a different impulse than those particles, which are to be used to perform an irradiation. Without deflection of the particle beam by the magnet system 47 these particles may at least in part strike the object 37 to be irradiated. The quality of the irradiation of the target volume 35 would be degraded because these particles would release their energy at an undesired and also unpredictable position in the object 37.

The magnet system 47, however, may deflect the expanded particles, such that the expanded particles experience a deflection different to those particles of the particle beam which are to be used to perform the irradiation. This is symbolized in the drawing by the dotted curves 53. The magnetic field these particles are at least partially separated spatially from the desired particles of the particle beam. The quality of the irradiation of the target volume 35 may be improved in this manner.

The first collimator 43, which is used for shaping the particle beam may, for example, be a collimator individually customized to the target volume 35. Alternatively, a multi-leaf collimator whose aperture can be flexibly customized to a target volume 35 to be irradiated may be used as the collimator 43. A further embodiment variant is a collimator 43, which is assembled from ready-made elements such that its aperture corresponds to the target volume 35.

FIG. 3 shows a further embodiment of a particle beam application apparatus 31. In contrast to the particle beam application apparatus 31, which is shown in FIG. 2, the first collimator 43′ may be slimmer. The particles of the particle beam, which do not pass through the aperture 45 of the first collimator 43′, merely have their energy attenuated instead of being completely removed from the particle beam. The particles, which do not pass through the aperture 45 of the first collimator 43′, are deflected differently by the following magnet system 47 from those particles, which are guided unattenuated through the first collimator 43′, for example, through the aperture of the first collimator 43′. This is symbolized in FIG. 3 by the dotted curves 55.

Since the target volume 35 is positioned at an appropriate point downstream of the magnet system 47, only those particles strike the target volume 35, which have experienced a corresponding deflection in the magnet system 47. Other particles, such as, for example, those which have experienced an attenuation by the first collimator 43′, are deflected more strongly in the magnet system 47, such that they do not strike the target volume 35.

FIG. 3 shows a depth modulation device 57. The particle beam passes though the depth modulation device 57. The depth modulation device 57 may for example, have a moderator wheel or a ridge filter. The energy of the particle beam is set appropriately by the depth modulation device 57, such that the particle beam releases its energy at a particular depth within the target volume 35. The entire target volume 35 may, for example, be irradiated in layers. An arrangement of the depth modulation device 57 in the area of the entering particle beam 33 is shown here. In one embodiment, the depth modulation device may be arranged at a different point, for example, in the deflected particle beam 51 or upstream of the deflection.

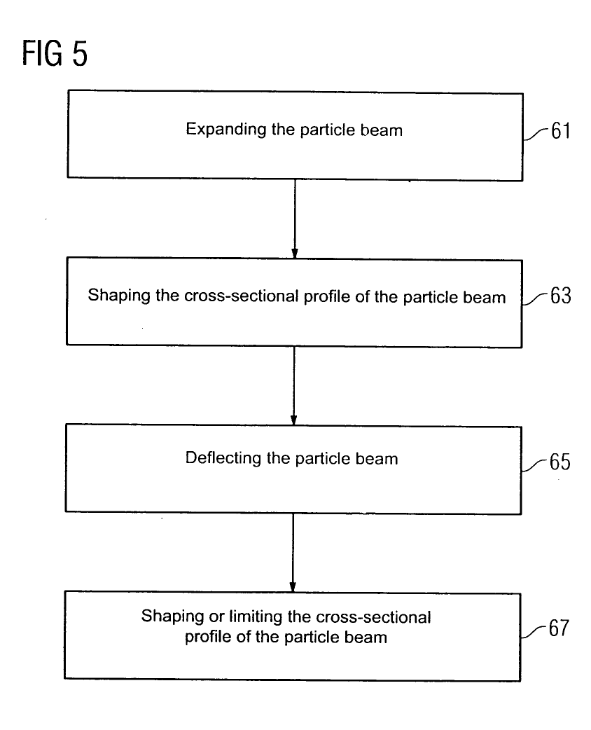

FIG. 4 shows a further embodiment of the particle beam application apparatus 31 in which a further, second collimator 59 is arranged downstream of the magnet system 47.

The second collimator 59 shapes the cross-sectional profile of the deflected particle beam 51 once again before the particle beam strikes the target volume 35 or the object 37. The precision of the irradiation is increased by the second collimator 59. Through the use of the second collimator 59, it is possible for the first collimator 43 to be customized less precisely to the target volume because a possible fine tuning can be achieved by the second collimator 59.

In one example, a multi-leaf collimator is used as the first collimator 43. The multi-leaf collimator may be configured more simply because the shape of the target volume needs to be mapped less precisely by the multi-leaf collimator. The same applies to a collimator, which is customized individually to the target volume or is assembled from ready-made elements. Such a collimator may be manufactured more quickly and cheaply because it needs to be customized less precisely to the target volume.

The second collimator 59 may be customized less precisely to the shape of the target volume 35 if a precise customization of the cross-sectional profile of the particle beam has already been performed by the first collimator 43 in a precise manner. Like the first collimator 43, the second collimator 59 may, for example, be a multi-leaf collimator, a collimator produced individually for the target volume to be irradiated or a collimator which can be assembled from ready-made elements.

FIG. 5 shows an overview of a method for guiding a particle beam. The method may be executed using an embodiment of the particle beam apparatus 31, as shown in FIGS. 2 to 4.

In a first optional act 61, an expansion of the particle beam takes place. In a second act 63, shaping of the cross-sectional profile of the particle beam takes place, as is shown for example with reference to a first collimator in FIGS. 2 to 4. In a third act 65, the particle beam is subjected to deflection by a magnetic field, by which the particle beam is cleansed of scattered radiation as described. In a fourth optional act 67, further limiting of the cross-sectional profile of the particle beam occurs, as is shown, for example, with reference to the second collimator in FIG. 4.

1. A particle beam application apparatus for shaping and guiding a particle beam, the apparatus comprising:
a first collimator having an aperture for shaping a cross-sectional profile of a particle beam entering the collimator, and
a magnet system that is operable to deflect the particle beam, which is arranged in the beam path of the particle beam downstream of the first collimator, the magnet system being operable to generate a magnetic field with which the particle beam is fanned out spectrally.

2. The particle beam application apparatus as claimed in claim 1, wherein the aperture of the first collimator is based on a target volume to be irradiated.

3. The particle beam application apparatus as claimed in claim 1, wherein the first collimator for shaping the cross-sectional profile of the particle beam entering the first collimator attenuates the energy of the particles of the particle beam, which do not pass through the aperture of the collimator.

4. The particle beam application apparatus as claimed in claim 1, wherein the deflection of the particle beam generated by the magnet system is more than 5°.

5. The particle beam application apparatus as claimed in claim 1, wherein the magnet system comprises at least one dipole magnet.

6. The particle beam application apparatus as claimed in claim 1, wherein the first collimator is a collimator that is produced individually for the target volume to be irradiated, a collimator that is assembled from ready-made elements, or a multi-leaf collimator.

7. The particle beam application apparatus as claimed in claim 1, comprising: a beam expansion device which is arranged in the beam path upstream of the first collimator.

8. The particle beam application apparatus as claimed in claim 1, comprising: a second collimator arranged downstream of the magnet system in the beam path for limiting the cross-sectional profile of the particle beam emerging from the magnet system.

9. The particle beam application apparatus as claimed in claim 8, wherein the second collimator is a collimator that is produced individually for the target volume to be irradiated, a collimator that is assembled from ready-made elements, or a multi-leaf collimator.

10. The particle beam application apparatus as claimed in claim 1, comprising: a depth modulation device that is arranged in the beam path of the particle beam and is operable to vary the energy of the particle beam passing through the depth modulation device.

11. A radiation device, comprising:
at least one particle beam application apparatus,
at least one source for generating particles, and
at least one acceleration device arranged upstream of the particle beam application apparatus in order to accelerate the particles and to generate the particle beam from the accelerated particles
wherein the at least one particle beam application apparatus includes a first collimator having an aperture for shaping a cross-sectional profile of a particle beam entering the collimator, and a magnet system that is operable to deflect the particle beam, which is arranged in the beam path of the particle beam downstream of the first collimator, the magnet system being operable to generate a magnetic field with which the particle beam is fanned out spectrally.

12. A method for guiding a particle beam, the method comprising:
shaping a cross-sectional profile of a particle beam,
guiding the shaped particle beam through a magnetic field, as a result of which the particle beam is deflected and fanned out spectrally.

13. The method as claimed in claim 12, wherein the cross-sectional profile of the particle beam is shaped such that the particle beam is customized to a target volume to be irradiated.

14. The method as claimed in claim 12, wherein shaping the cross-sectional profile of the particle beam includes guiding the particle beam through a collimator with an aperture, wherein during the passage of the particle beam through the collimator those particles which do not pass through the aperture of the collimator merely have their energy attenuated.

15. The method as claimed in claim 12, wherein the shaped particle beam is being guided through the magnetic field the particle beam is deflected by more than 5°, in particular more than 10°.

16. The method as claimed in claim 12, wherein the particle beam is expanded prior to shaping the cross-sectional profile of the particle beam.

17. The method as claimed in claim 12, wherein after being guided through the magnetic field the cross-sectional profile of the particle beam is limited.

18. The method as claimed in claim 12, wherein the energy of the particles of the particle beam passing through the depth modulation device is attenuated in the beam path by a depth modulation device.

19. The particle beam application apparatus as claimed in claim 4, wherein the deflection of the particle beam generated by the magnet system is more than 10°.

20. The particle beam application apparatus as claimed in claim 1, wherein the first collimator for shaping the cross-sectional profile of the particle beam entering the first collimator attenuates only the energy of the particles of the particle beam, which do not pass through the aperture of the collimator.
